(19) United States
(12) Patent Application Publication
(10) Pub. No.: US 2008/0102176 A1
(43) Pub. Date: May 1, 2008

(54) Method for Extracting Plant Fats

(76) Inventor: Ying Fong WU, Kaohsiung (TW)

Correspondence Address: Dr. BANGER SHIA;Int''l Patent Office of Bang Shia, 102 Lindencrest Ct, Sugar Land, TX, 77479-5201, US

(21) Appl. No.: 11/552,969

(22) Filed: Oct. 26, 2006

(51) Int. Cl. A23C 15/14

(52) U.S. Cl. 426/417

(57) ABSTRACT

A method for extracting plant fats includes pulverizing cellulose-containing raw material into particles of 1-2 mm in diameter. The particles are immersed in thin sulfuric acid for acidification. The acidified particles are fermented and then extracted by solvent to obtain plant fats, which can be converted into biodiesel after esterification. No drying procedure is required in the method, and the cost for extracting plant fats is largely cut.

### BACKGROUND OF THE INVENTION

1. Field of the Invention

The present invention relates to a method for extracting fats and, more particularly, to a method for extracting plant fats.

2. Description of the Related Art

Conventionally, there are two ways for extracting fats from fibers of plants: oil solvent extraction and screw press. In oil solvent extraction, n-hexane is a typical solvent for dissolving fats in the plant fibers for low cost and abundant resources in addition to excellent dissolving effect. However, since the raw materials are directly immersed in n-hexane in this approach, residual n-hexane on the extracted fats may transform into vapor and thus adversely affect the human central nervous system and result in motor neuropathy in the human body exposed to the vapor. N-hexane is officially ruled polluting substances to air in some countries due to low flash point that causes environmental problems. Hence, generating eatable fats by oil solvent extraction is debatable.

In screw press, raw materials are pressed with a screw rod through mechanical operation to obtain fats. A drying process is often required to remove water contents from the raw materials before the pressing step. No solvent is used for healthy consideration. However, the equipment for carrying out the drying process is expensive and consumes energy much more than that required by oil solvent extraction. More specifically, the drying process costs about 85-90% of the overall cost of the screw press approach, and the remained oil is about 5%-7% compared to below 1% in the oil solvent extraction approach. Namely, the cost of the screw press approach is much higher than that of the oil solvent extraction approach.

Petroleum is one of the most important energy resources now, yet the remaining amount of petroleum decreases dramatically due to massive exploitation. Substitutive energy for oil is important. Biodiesel is one of the solutions and causes pollution far less than petroleum diesel, and use of biodiesel only requires slight modification to the current diesel engine. Known raw materials for biodiesel includes various animal fats and mainstream plant fats. Biodiesel can be obtained after esterification. Most current methods for extracting plant fats are for eating purposes such that the costs of using these methods to generate biodiesel are relatively high (about two or three times of that of petroleum oil) in which the cost of the raw material fats is about 75% of the overall cost. Hence, the producing cost of the biodiesel can be largely reduced (which makes biodiesel more competitive) if the cost of the raw material fats can be reduced.

The producing cost of the plant fats is mainly the raw materials and the process. As control of the prices of the raw materials is difficult and even impossible, improvement on the process for producing plant fast would be more feasible.

### SUMMARY OF THE INVENTION

An objective of the present invention is to provide a method for extracting plant fats at a low cost, thereby providing cheap plant fats for industrial use.

A method for extracting plant fats in accordance with the present invention comprises:

pulverizing cellulose-containing raw material into a plurality of particles of 1-2 mm in diameter;

immersing the particles in thin sulfuric acid to acidify the particles for enhancing hydrolysis and adjusting PH value to 4.5±0.5;

removing the acidified particles from the thin sulfuric acid and adding cellulase and oil-generating yeast in sequence to the acidified particles for fermentation for 8-9 days in an environment at a temperature of 25-30° C. and a humidity of 85-90%, with the acidified particles, the cellulase and the oil-generating yeast being turned over and ventilated during turning over to obtain fermentation products;

adding a solvent of aliphatic hydrocarbon into the fermentation products to extract fats, thereby obtaining extraction mixture; and

removing acidified particles remained in the extraction mixture and separating the fats from the solvent by distillation to thereby obtain raw oil.

The solvent of aliphatic hydrocarbon may be selected from a group consisting of pentane, n-hexane, and octane.

Alternatively, the solvent includes propane and butane mixed at a ratio of 1:1.

Preferably, the cellulase is trichoderma viride and the oil-generating yeast is Rhodotorula glutinis.

Preferably, the turning over rate in is every hour in the first day, every three hours in the second day, and every six hours in the third day.

Preferably, trichoderma viride is inoculated in the beginning and the Rhodotorula glutinis is inoculated in the second turning over.

Preferably, a weight ratio between the raw material, trichoderma viride, and Rhodotorula glutinis is 100:0.1:0.5.

Preferably, the fasts are separated from the solvent by three distillation procedures that are carried out at 80° C., 110° C., and 135° C., respectively, and the three distillation procedures are repeated six times.

Other objectives, advantages, and features of the invention will become more apparent from the following detailed description when taken in conjunction with the accompanying drawings.

### BRIEF DESCRIPTION OF THE DRAWINGS

FIG. 1 is a flowchart illustrating a method for extracting plant fats in accordance with the present invention.

FIG. 2 is a schematic diagram illustrating a fermenting device for carrying out a fermenting step of the method in accordance with the present invention.

### DETAILED DESCRIPTION OF THE PREFERRED EMBODIMENT

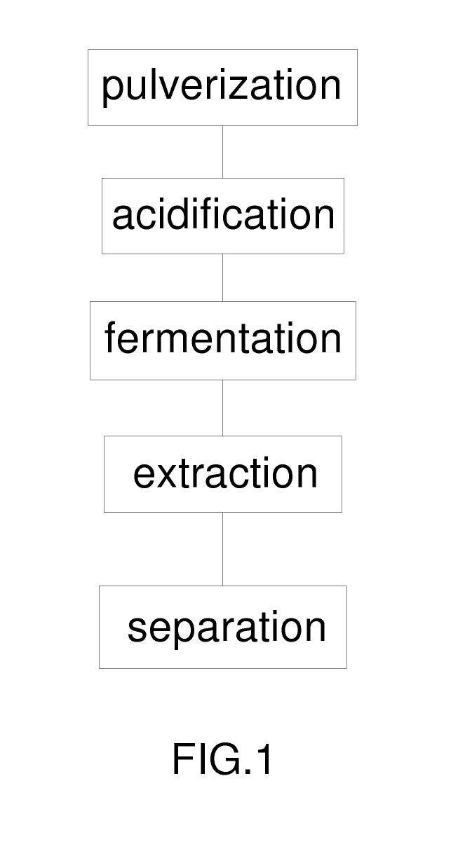

Referring to FIG. 1, a method for extracting plant fats in accordance with the present invention comprises pulverizing a raw material into particles, acidifying the particles, fermenting the acidified particles, extracting fats, and extracting biodiesel by separation.

More specifically, a raw material is firstly pulverized into a plurality of particles of 1-2 mm in diameter. The particles are then acidified by immersion in thin sulfuric acid of a concentration of 1-2%. Cellulase and oil-generating yeast are added in sequence to the acidified particles separated from the thin sulfuric acid for fermentation, obtaining fermentation products including little amount of water, oil-generating microorganism, unhydrolyzed cellulose. The fermentation products are immersed in a solvent to extract fats, and the fats are then separated from the solvent.

The raw material may include plants with abundant cellulose, such as wood rusts, corncobs, corn stalks, rice stems, wheat stalks, rice shells, bran, or waste wood dusts after being used for breeding mushrooms or the like. The raw material is pulverized into particles of 1-2 mm in diameter, as mentioned above.

After pulverization, the particles are immersed in thin sulfuric acid of a concentration of 1%-2%. This acidification step enhances hydrolysis of cellulose and adjusts the PH value to 4.5±0.5 for subsequent fermentation. The acidified particles are separated from the thin sulfuric acid by a sieve, mesh, or the like.

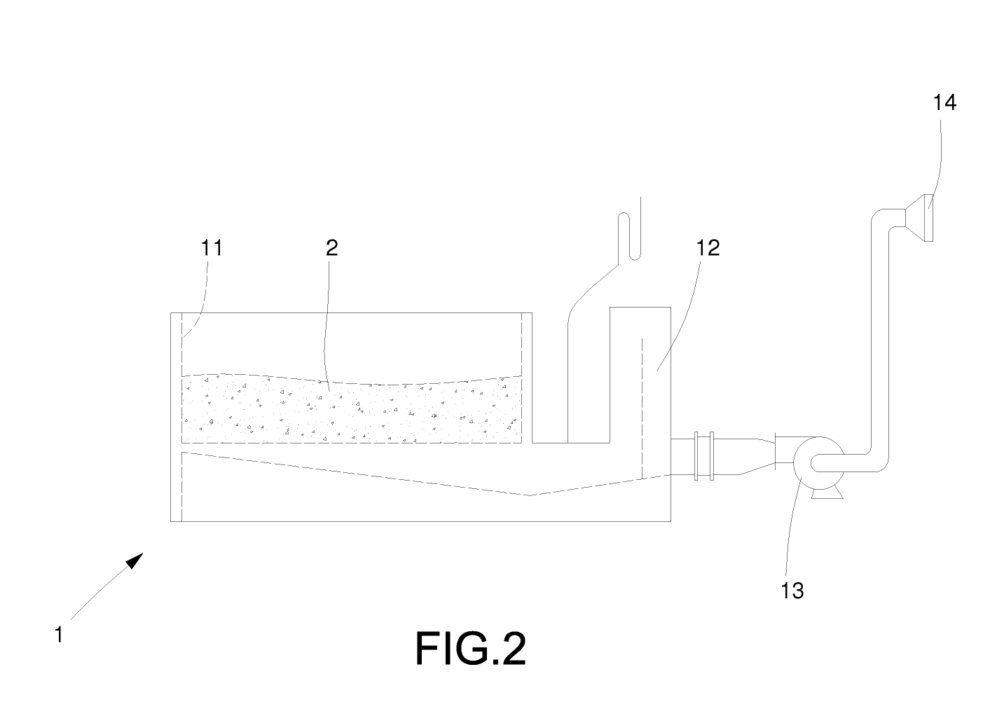

With reference to FIG. 2, the acidified particles are placed in a fermenting device. The fermenting device may be a conventional device and illustrated schematically. In this example, the fermenting device includes a chamber 11 for receiving raw material 2, a channel 12 having an outer end to which a blower 13 is mounted. A filter 14 is mounted in an inlet side of the blower 13. The acidified particles are placed in the chamber 11. Then, cellulase and oil-generating yeast are added in sequence into the chamber 11 for fermentation purposes, which will be described in detail later.

The environment for fermentation is at a temperature of 25-30° C., a humidity of 85%-90%, and a PH value of 4.5±0.5. The fermentation requires 8-9 days. Preferably, the acidified particles, the cellulase, and oil-generating yeast are turned over every hour in the first day, every three hours in the second day, and every six hours in the third day. Turning over may be accomplished by a stainless turner or a roller-type turning device. Ventilation is provided during turning over. By using the blower 13, air is passed through the filter 14 and the channel 12 into the chamber 11 via a bottom of the chamber 11. The cellulase may be trichoderma viride and the oil-generating yeast may be Rhodotorula glutinis. Trichoderma viride is inoculated in the beginning whereas the Rhodotorula glutinis is inoculated in the second turning over. The weight ratio between the raw material, trichoderma viride, and Rhodotorula glutinis is 100:0.1:0.5. The fermentation products include unhydrolyzed cellulose, the oil-generating yeast, and little amount of water, as mentioned above. The purpose of solid fermentation is turning cellulose into oil-generating microorganism that contains high percentage of fats.

Drying procedures are not required in the method for extracting plant fats in accordance with the present invention. After fermentation, solvent is added into the fermentation products for extracting fats. Hence, the costs for the drying devices and energy required for operating the drying devices can be cut. The solvent may be aliphatic hydrocarbon such as pentane, n-hexane, octane, and #4 solvent (Chinese National Standard). In #4 solvent that is suitable for mass production, propane and butane are mixed at a ratio of 1:1.

The fermentation products are immersed in the solvent (preferably n-hexane) to retract fats, and the conversion rate is about 7.5%. More specifically, n-hexane is added to the fermentation products for extracting the fats. The products in the extraction step are referred to as “extraction mixture”.

Next, the extraction mixture is subjected to a separation step for separating the fats from the solvent. The remaining acidified particles in the extraction mixture are filtered first, and the n-hexane solution undergoes three distillation procedures that repeat six times to separate the fats from the solvent, thereby obtaining raw oil. The first, second, and third distillations are carried out at 80° C., 110° C., and 135° C., respectively. The distillation times depend on the amount of the solution. The three distillation procedures are repeated six times to separate the fats from the solvent. Raw oil is thus obtained. The fats can be converted into biodiesel after esterification.

The method for extracting fats in accordance with the present invention can be used to product cheap fats for industrial use. No drying procedure is required in the method, and oil solvent extraction is used to substitute drying and pressing procedures. The costs for the drying device and energy for operating the drying device are cut. The large percentage of the cost of the drying device in the conventional screw press approach is no longer a problem, as the method in accordance with the present invention replaces the drying procedure with oil solvent extract. The oil-producing cost is largely cut.

For example, 1.108 tones of plant fats are required for producing 1 tones of biodiesel by the method in accordance with the present invention. Using 14.773 tones of corn stalks as the raw material, the average cost for producing biodiesel is about NT $6.00 per liter (the energy consumption and equipment depreciation are not considered), which is quite competitive in the market.

Although a specific embodiment has been illustrated and described, numerous modifications and variations are still possible. The scope of the invention is limited by the accompanying claims.

What is claimed is:

1. A method for extracting plant fats comprising:
pulverizing cellulose-containing raw material into a plurality of particles of 1-2 mm in diameter;
immersing the particles in thin sulfuric acid to acidify the particles for enhancing hydrolysis and adjusting PH value to 4.5±0.5;
removing the acidified particles from the thin sulfuric acid and adding cellulase and oil-generating yeast in sequence to the acidified particles for fermentation for 8-9 days in an environment at a temperature of 25-30° C. and a humidity of 85-90%, with the acidified particles, the cellulase and the oil-generating yeast being turned over and ventilated during turning over to obtain fermentation products;
adding a solvent of aliphatic hydrocarbon into the fermentation products to extract fats, thereby obtaining extraction mixture; and
removing acidified particles remained in the extraction mixture and separating the fats from the solvent by distillation to thereby obtain raw oil.

2. The method as claimed in claim 1 wherein the solvent of aliphatic hydrocarbon is selected from a group consisting of pentane, n-hexane, and octane.

3. The method as claimed in claim 1 wherein the solvent includes propane and butane mixed at a ratio of 1:1.

4. The method as claimed in claim 1 wherein the cellulase is trichoderma viride and the oil-generating yeast is Rhodotorula glutinis.

5. The methods as claimed in claim 1 wherein the turning over rate in is every hour in the first day, every three hours in the second day, and every six hours in the third day.

6. The method as claimed in claim 5 wherein the cellulase is trichoderma viride and the oil-generating yeast is Rhodotorula glutinis.

7. The method as claimed in claim 6 wherein trichoderma viride is inoculated in the beginning and the Rhodotorula glutinis is inoculated in the second turning over.

8. The method as claimed in claim 6 wherein a weight ratio between the raw material, trichoderma viride, and Rhodotorula glutinis is 100:0.1:0.5.

9. The method as claimed in claim 7 wherein a weight ratio between the raw material, trichoderma viride, and Rhodotorula glutinis is 100:0.1:0.5.

10. The method as claimed in claim 1 wherein the fasts are separated from the solvent by three distillation procedures that are carried out at 80° C., 110° C., and 135° C., respectively, and the three distillation procedures are repeated six times.
